(19) United States
(12) Patent Application Publication
(10) Pub. No.: US 2009/0029174 A1
(43) Pub. Date: Jan. 29, 2009

(54) Process for manufacturing glass/plastic laminates with improved optical quality

(76) Inventors: Cynthia H. Kirschner, Washington, WV (US); Jerrel C. Anderson, Vienna, WV (US); Luther W. Center, Circleville, OH (US); Charles Anthony Smith, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/220,633

(22) Filed: Jul. 24, 2008

Related U.S. Application Data
(60) Provisional application No. 60/961,870, filed on Jul. 24, 2007.

(51) Int. Cl. B32B 17/10; B32B 38/10; B32B 27/36; B32B 37/00; B32B 27/00

(52) U.S. Cl. 428/413; 156/247; 428/411.1; 428/426; 428/480; 156/60; 428/447; 428/423.1; 428/522

(57) ABSTRACT

Provided is a process for manufacturing a glass/plastic laminate or a glass-less laminate having improved optical qualities. The process involves the use of a bi-layer film as a removable release liner. The bi-layer film comprises an inbound layer and an outbound layer. In the lamination process, the inbound layer is disposed adjacent to the plastic film outer layer and the outbound layer is disposed adjacent to a rigid cover plate. The polymeric material comprised in the outbound layer has a melting temperature that is higher than the temperature reached by the outbound layer in the lamination process. The melting temperature of the inbound layer is preferably at least 10° C. higher than the melting temperature of the outbound layer. Preferred bi-layer release liners include polyethylene/polypropylene films.

### CROSS-REFERENCE TO RELATED APPLICATION

This application claims priority to U.S. Provisional Application No. 60/961870, filed on Jul. 24, 2007, which is incorporated herein by reference in its entirety.

### FIELD OF THE INVENTION

The present invention relates to a process for manufacturing glass-less and glass/plastic laminates with improved optical quality. In particular, an improved release liner having at least two layers is described.

### BACKGROUND OF THE INVENTION

Glass laminated products or “safety glass” have contributed to society for almost a century. Safety glass is characterized by high impact and penetration resistance, and by minimal scattering of glass shards and debris upon shattering. The laminates typically consist of two outer layers formed of glass panels and/or polymeric films and, sandwiched between the two outer layers, an interlayer formed of one or more polymeric films or sheets. In a glass/plastic laminates, one outer layer is derived from (or made of) a glass sheet and the other is derived from (or made of) a plastic film or sheet. In glass-less laminates, the two outer layers are both derived from (or made of) plastic films or sheets, which may be the same or different. Often times, the plastic film or sheet bears an abrasion-resistant hardcoat on the surface that is outside the laminate.

The preparation of glass/plastic laminates and glass-less laminates for use in safety glazing applications presents unusually stringent manufacturing requirements in order to provide a product with acceptable optical quality. Although described in terms of the production of glass/plastic laminates, the following techniques and observations apply equally to glass-less laminates.

Typically, glass/plastic laminates are produced in the following manner: (a) assemble all the component layers of a glass/plastic laminate in the order of a glass (outer) layer, a polymeric interlayer, and an optionally hardcoated plastic film (outer) layer; (b) further place a cover plate similarly shaped as the glass outer layer over the hardcoated plastic film layer to form a pre-lamination assembly; (c) apply heat and/or pressure to the assembly; and (e) remove the cover plate from the final glass/plastic laminates. In this operation the polymeric interlayer is bonded between the glass layer and the plastic film layer, and the outside surface of the plastic film layer is molded to replicate the surface of the cover plate.

Disadvantageously, the resulting glass/plastic laminates do not always have adequate optical quality. Specifically, during the lamination steps, any particulate contaminate between the cover plate and the hardcoated plastic film layer remains on the surface of the plastic film layer and may become embedded in the plastic surface of the laminate, notwithstanding the presence of a hardcoat on the plastic film. After cooling, depressurization, and cover plate removal, the particulate contaminant leaves permanent depressions on the surface of the resulting laminate. These depressions are objectionable optical defects.

Moreover, the damage done by very small particles can be observed by the naked eye. For example, the visibility threshold for particles is typically 10 to 25 μm in diameter. The cone-like defect caused by pressing a particle against a relatively non-elastic film, such as a polyester film, has a diameter that may be about ten times as large as the diameter of the particle, however. Thus, a particle as small as 3 to 5 μm in diameter may cause a visible defect in a glass/plastic laminate. In the absence of drastic corrective measures, such as repeating the heating and pressurization steps of the lamination, for example, the depressions formed by the particle are permanent. Therefore, simply removing the particles from the surface of the laminate does not cure the optical defects.

Efforts to solve this problem by modifying the surface of the cover plate have not been entirely successful. Obtaining optimum optical quality has generally required labor intensive cleaning procedures, or the effort and expense of maintaining a clean room atmosphere.

Other attempts to solve this problem include the use of “pre-masks” or “release liners”. For example, U.S. Pat. No. 5,631,089, issued to Center, Jr., et al., discloses a process in which the pre-lamination assembly comprises a release liner that is formed of a soft plastic film and placed between the glass cover plate and the hardcoated plastic film layer of the laminate. It is expected that, during the lamination process, any particulate contaminants that may be trapped between the cover plate and the release liner will be pressed into the surface of the release liner rather than into the surface of the laminate. Stated alternatively, it is theorized that, after cooling, depressurization and cover plate removal, most particulate contaminates will be removed by stripping off the release liner to leave a final laminate with acceptable optical quality.

The physical properties of the materials used in the release liners may dictate the quality of the final lamination products, however. For example, the same U.S. Pat. No. 5,631,089 discloses the use of a polyethylene film or a polypropylene film, among others, as the release liner. Since polypropylene has a relatively high melting temperature, compared to typical lamination temperatures, it may not be an effective material to entrap the particulate contaminants. Moreover, if the surface of the polypropylene film is not smooth, it has a tendency to leave visible impressions on the surface of the laminate. On the other hand polyethylene, due to its relatively low melting temperature, has the propensity to melt too soon and therefore trap air in pockets across the surface of the laminate, again causing undesirable visible surface imperfections.

In light of the above, it is apparent that there is a need in the art to develop an improved pre-mask or release liner that is useful in manufacturing glass/plastic or glass-less laminates with desirable optical quality.

### SUMMARY OF THE INVENTION

Provided herein are processes for preparing a glass/plastic laminate. In these processes, a pre-lamination structure is laid up, comprising, in the order given: a glass outer layer, an interlayer, a plastic outer layer, a release liner, and a rigid cover plate. The layers of the pre-lamination structure are bonded by applying sufficient heat, pressure or heat and pressure between the glass outer layer of the pre-lamination structure and the rigid cover plate. The glass/plastic laminate is obtained by removing the cover plate and the release liner.

In one process, the release liner is a bi-layer film comprising an inbound layer comprising a first polymeric material and an outbound layer comprising a second polymeric material. The second polymeric material has a melting temperature at least 10° C. higher than the melting temperature of the first polymeric material. In addition, the inbound layer of the release liner is proximal to the plastic outer layer and the outbound layer is proximal to the rigid cover plate.

In another process, the bi-layer release liner has a total thickness of up to about 5 mils (127 μm) or about 1 to about 4 mils (about 25 to about 102 μm). The inbound layer of the release liner has a thickness not exceeding 1.5 mils (38 μm) and comprises a polyethylene with a melting temperature of about 110° C. to 115° C. The outbound layer has a thickness not exceeding 3 mils (76 μm) and comprises a polypropylene with a melting temperature of about 160° C. to 170° C.

In a process for preparing a glass-less laminate, the pre-lamination structure comprises, in the order given: a first rigid cover plate, a first release liner, a first plastic outer layer, an interlayer, a second plastic outer layer, a second release liner, and a second rigid cover plate. The layers of the pre-lamination structure are bonded by applying sufficient heat, pressure or heat and pressure between the cover plates of the pre-lamination structure. The glass-less laminate is obtained by removing the cover plates and the release liners. The release liners are as described above. They may be the same as or different from each other.

Further provided is a laminated structure comprising a first and a second outer layer, a polymeric interlayer, and at least one bi-layer release liner as described above.

Yet further provided is a pre-lamination assembly comprising a first and second outer layer, a polymeric interlayer, at least one bi-layer release liner, and at least one rigid cover plate, wherein, (a) at least one of the two outer layers is a plastic outer layer and the polymeric interlayer is placed between the two outer layers; (b) the at least one bi-layer release liner has an inbound layer comprising a first polymeric material and being proximal to the plastic outer layer and an outbound layer comprising a second polymeric material and being proximal to the rigid cover plate; (c) the second polymeric material has a melting temperature at least 10° C. higher than the melting temperature of the first polymeric material; and (d) the at least one bi-layer release liner is placed between the plastic outer layer and the at least one rigid cover plate with the inbound layer of the at least one release liner proximal to the plastic outer layer and the outbound layer of the at least one release liner proximal to the at least one rigid cover plate.

### BRIEF DESCRIPTION OF THE DRAWINGS

FIG. 1 illustrates the steps of one process for manufacturing a glass/plastic laminate. The process includes the steps of (a) forming a pre-lamination assembly comprising, in order, a glass cover plate (18), a bi-layer release liner (10) with the outbound layer (10A) adjacent to the glass cover plate (18), a hardcoated polyester film outer layer (12) with the inbound layer (10B) of the bi-layer release liner (10) adjacent thereto, an interlayer (14), and a glass outer layer (16); (b) applying heat and pressure to the assembly; (c) removing the cover plate; and (d) stripping the bi-layer release liner from the final glass/plastic laminate.

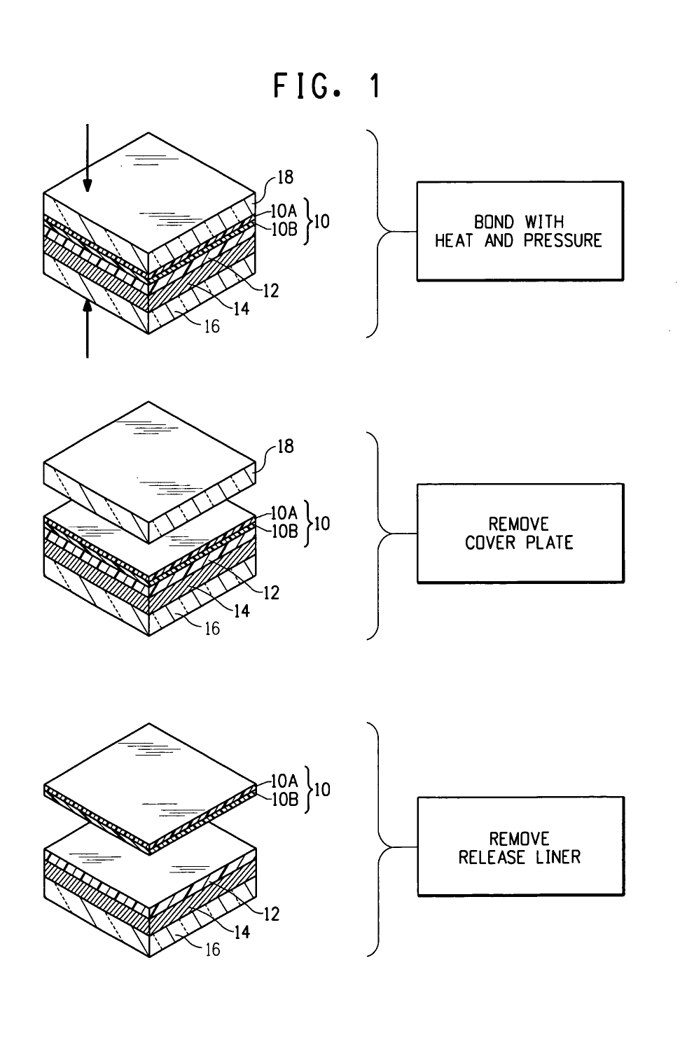

### DETAILED DESCRIPTION OF THE INVENTION

Several patents, patent applications and publications are cited in this description in order to more fully describe the state of the art to which this invention pertains. The entire disclosure of each of these patents, applications and publications is incorporated by reference herein.

Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the invention, suitable methods and materials are described herein.

### Definitions

The following definitions apply to the terms as used throughout this specification, unless otherwise limited in specific instances.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.” Optional additives as defined herein, at levels that are appropriate for such additives, and minor impurities are not excluded from a composition by the term “consisting essentially of”, however.

Where an invention or a subcombination thereof is described with an open-ended transitional phrase such as “comprising,” unless otherwise stated in specific instances, the term should be interpreted to include a description of the invention or subcombination using the transitional phrases “consisting essentially of” and “consisting of”. Likewise, unless otherwise stated, an invention or subcombination described using the transitional phrase “consisting essentially of” also includes a description of the invention or subcombination using the transitional phrase “consisting of”.

The indefinite articles “a” and “an” are employed to describe elements and components of the invention. The use of these articles means that one or at least one of the elements or components so modified is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

Polymers may be defined herein by reference to the monomers used to make them or by the amounts of the monomers used to make them. Such a description may not include a formal nomenclature commonly used to describe the final polymer, or may not contain product-by-process terminology. Nevertheless, any such reference to monomers or amounts of monomers means that the polymer is made from those monomers or from those amounts of the monomers, and also refers to the corresponding polymers and compositions thereof.

The terms “sheet” and “film” are used interchangeably herein, as each layer of the structures described, unless otherwise indicated in specific circumstances, may be formed from a film or a sheet. In general, however, a sheet is thicker than a film. For example, a sheet may have a thickness of about 10 mils (0.25 mm) or greater.

The materials, methods, and examples herein are illustrative only and, except as specifically stated, are not intended to be limiting.

Described herein is a lamination process for preparing glass-less laminates and glass/plastic laminates with improved optical quality. In particular, the process involves the use of a release liner formed of a bi-layer polymeric film.

### Glass/Plastic and Glass-Less Laminates

As used here, the term “glass/plastic laminate” refers to a lamination structure comprising a glass outer layer, a plastic film or sheet outer layer, and an interlayer bonded between the two outer layers. Similarly, the term “glass-less laminate” refers to a laminate both of whose outer layers are plastic films or sheets that may be the same or different. One exemplary type of glass-less laminates is described in U.S. Pat. No. 7,147,923, issued to Roberts et al.

Significantly, both the glass/plastic laminates and the glass-less laminates are defined by their outer layers alone. One or more glass layers or other rigid layers may be present between the laminates' two outer layers, however, without affecting the efficacy of the methods described herein.

The term “glass”, as used herein, refers to window glass, plate glass, silicate glass, sheet glass, low iron glass, and float glass, and also includes colored glass, specialty glass which includes ingredients to control, for example, solar heating, coated glass with, for example, sputtered metals, such as silver or indium tin oxide, for solar control purposes, E-glass, Toroglass, Solex® glass (PPG Industries, Pittsburgh, Pa.) and the like. Such specialty glasses are disclosed in, e.g., U.S. Pat. Nos. 4,615,989; 5,173,212; 5,264,286; 6,150,028; 6,340,646; 6,461,736; and 6,468,934. The glass may also include frosted or etched glass sheets. Suitable frosted and etched glass sheets are articles of commerce and are well known in the art. The type of glass to be selected for a particular laminate depends on the intended use. Preferably, the glass that is used in the methods described herein is in the form of sheets.

The methods described herein are also useful when smoothness is a desirable quality although there is no requirement for optical quality. Under these circumstances, opaque materials, such as metals or ceramics, may be used in place of one or more glass sheets.

Although glass is a preferred material, other transparent rigid sheets may be included in the laminates, including, without limitation, sheets of polycarbonate, acrylic, polyacrylate, poly(methyl methacrylate), cyclic polyolefins (e.g., ethylene norbornene polymers), and polystyrene (preferably metallocene-catalyzed) and the like and combinations thereof. Preferably, the rigid sheet comprises a material with a modulus of about 100,000 psi (690 MPa) or greater (as measured by ASTM Method D-638). Preferably the non-glass rigid sheet is formed of polycarbonate, poly(methyl methacrylate), or combinations thereof.

The plastic film or sheet outer layer used here may be derived from (or made of) any known polymeric materials, which include, but are not limited to, polyesters, acrylics, polyacrylates, polyurethanes, poly(methyl methacrylates), polyvinyl fluorides, polyvinylidene chlorides, cellulose acetates, cellulose esters, polycarbonates, cyclic polyolefins (e.g., ethylene norbornene polymers), polystyrenes (preferably metallocene-catalyzed), acid copolymers of α-olefins and α,β-unsaturated carboxylic acids having from 3 to 8 carbons, and ionomers derived from partially or fully neutralized acid copolymers of α-olefins and α,β-unsaturated carboxylic acids having from 3 to 8 carbons. The thickness of the plastic films or sheets will vary depending on the particular end use or application for which the laminate is intended. Thickness in the range of about 2 to about 30 mils (about 51 to about 762 μm), or about 2 to about 14 mils (about 51 to about 356 μm), is generally preferred. It is preferred, however, that the plastic outer layer be a polyester film, or more preferably an uni-axially or bi-axially oriented polyester film, or yet more preferably an uni-axially or bi-axially oriented poly(ethylene terephthalate) (PET) film.

It is also preferred that the plastic outer layer have a clear abrasion-resistant hardcoat applied to its outside surface. The term “outside surface” is used herein to refer to the surface of the plastic layer which is further away from or “distal to” the polymeric interlayer of the laminate, while the term “inside surface” is used herein to refer to the surface that is closest or “proximal to” and preferably in direct contact with the polymeric interlayer.

Suitable abrasion-resistant hardcoats may be formed of polysiloxanes or cross-linked (thermosetting) polyurethanes, such as those disclosed in U.S. Pat. Nos. 5,069,942; 5,567,529 and 5,763,089. Polysiloxane coated PET films can be obtained commercially from E. I. du Pont de Nemours and Company of Wilmington, Del. (hereinafter “DuPont”). Also applicable here are the oligomeric-based coatings disclosed in U.S. Patent Appln. Publn. No. 2005/0077002, which comprise a combination of at least one hydroxyl- or anhydride-containing oligomer and at least one isocyanate or epoxy-containing oligomer.

In practice, prior to applying the hardcoat, the outside surface of the plastic films may undergo certain energy treatments or be coated with certain primers to enhance the bonding between the plastic films and the hardcoats. The energy treatments may include a controlled flame treatment, a corona treatment, or a plasma treatment. For example, flame treating techniques have been disclosed in U.S. Pat. Nos. 2,632,921; 2,648,097; 2,683,984; and 2,704,382; corona treatment is described in U.S. Pat. No. 6,624,413; and plasma treatment techniques have been disclosed in U.S. Pat. No. 4,732,814.

The primers that are useful herein include, without limitation, silanes (e.g., amino-silanes), poly(alkyl amines) (e.g., poly(allyl amines) such as those described in U.S. Pat. Nos. 5,411,845; 5,770,312; 5,690,994; and 5,698,329), and acrylic based primers (e.g., hydroxyacrylic hydrosol primers, such as those described in U.S. Pat. No. 5,415,942).

Suitable polymeric interlayers may be single-layer or multi-layer polymeric sheets derived from (or made of) any polymeric material(s). The sheets preferably have a thickness of about 10 to about 250 mils (about 0.25 to about 6.35 mm), or more preferably about 15 to about 90 mils (about 0.38 to about 2.28 mm), or still more preferably about 30 to about 60 mils (about 0.76 to about 1.52 mm).

Suitable polymeric materials include, but are not limited to, poly(vinyl acetals) (including acoustic grade poly(vinyl acetals), copolymers of ethylene with vinyl acetate (“EVA”), poly(vinyl chlorides), polyurethanes, acid copolymers of α-olefins with α,β-unsaturated carboxylic acids having from 3 to 8 carbons, and ionomers derived from partially or fully neutralized acid copolymers of α-olefins and α,β-unsaturated carboxylic acids having from 3 to 8 carbons, or a combination of two or more thereof.

Moreover, the interlayer may further include non-polymeric layers. For example, an assembly such as “PVB/glass/PVB” is also encompassed by the term “interlayer” as it is used herein.

It is understood that the polymeric materials disclosed above may further comprise one or more suitable additives. The additives may include fillers, plasticizers, processing aides, flow enhancing additives, lubricants, pigments, dyes, colorants, flame retardants, impact modifiers, nucleating agents, lubricants, antiblocking agents such as silica, slip agents, thermal stabilizers, UV absorbers, UV stabilizers, thermal stabilizers, hindered amine light stablizers, dispersants, surfactants, chelating agents, coupling agents, adhesives, primers and the like. Those of skill in the art are able to formulate materials that comprise appropriate types and levels of additives. In general, however, each additive is present in the polymeric material at a level of about 0.01% to about 1% by weight, based on the total weight of the polymeric material.

Preferably, the polymeric interlayer comprises a poly(vinyl acetal), or more preferably, a poly(vinyl butyral) (“PVB”). Poly(vinyl acetal) may be synthesized by the condensation of polyvinyl alcohol with an aldehyde, such as acetaldehyde, formaldehyde, or butyraldehyde. The poly(vinyl acetal) compositions used herein also include acoustic grade compositions, which have a glass transition temperature (Tg) of 23° C. or less, or about 20° C. to about 23° C.

Suitable poly(vinyl acetal) interlayer compositions for use herein further include one or more plasticizers. Suitable plasticizer(s) include, without limitation, monobasic acid esters, polybasic acid esters or the like, organic phosphate and organic phosphite plasticizers. Specific examples of preferred monobasic esters include glycol esters prepared by the reaction of triethylene glycol with butyric acid, isobutyric acid, caproic acid, 2-ethylbutyric acid, heptanoic acid, n-octylic acid, 2-ethylhexylic acid, pelargonic acid (n-nonylic acid), decylic acid, and the like and mixtures thereof. Other useful monobasic acid esters may be prepared from tetraethylene glycol or tripropylene glycol with the above mentioned organic acids. Specific examples of preferred polybasic acid esters include those prepared from adipic acid, sebacic acid, azelaic acid, and the like and mixtures thereof, with a straight-chain or branched-chain alcohol having 4 to 8 carbon atoms. Specific examples of preferred phosphate or phosphite plasticizers include tributoxyethyl phosphate, isodecylphenyl phosphate, triisopropyl phosphite and the like and mixtures thereof. More preferred plasticizers include monobasic esters such as triethylene glycol di-2-ethylbutyrate, triethylene glycol di-2-ethylhexoate, triethylene glycol dicaproate and triethylene glycol di-n-octoate, and dibasic acid esters such as dibutyl sebacate, dioctyl azelate and dibutylcarbitol adipate.

Generally about 15 to about 80 parts of plasticizer(s) per hundred parts of poly(vinyl acetal) resin, preferably about 25 to about 60 parts of plasticizer per hundred parts of resin are used. Preferably the plasticizer(s) are used in an amount of about 30 to about 60 parts by weight per 100 parts by weight of an acoustic poly(vinyl acetal) composition. More preferably the plasticizer(s) are used in an amount of about 30 to about 55 parts by weight per 100 parts by weight of the acoustic poly(vinyl acetal).

Suitable polyvinyl butyral sheets are commercially available from DuPont under the Butacite® trademark.

Ethylene acid copolymers and ionomers thereof are other preferred polymeric materials for use in the interlayer. Suitable ethylene acid copolymers are include copolymers of α-olefins and one or more α,β-ethylenically unsaturated carboxylic acids having 3 to 8 carbons. Preferably, about 15 to about 30 wt %, or about 18 to about 25 wt %, or about 18 to about 23 wt %, of the repeat units of the ethylene acid copolymers are derived from the α,β-ethylenically unsaturated carboxylic acid(s). Preferably, the ethylene acid copolymers comprise repeat units derived from α-olefins having about 2 to about 10 carbon atoms, for example α-olefins selected from ethylene, propylene, 1-butene, 1-pentene, 1-hexene, 1-heptene, 3 methyl-1-butene, 4-methyl-1-pentene, and mixtures thereof. More preferably, the a-olefin used here is ethylene and the α,β-ethylenically unsaturated carboxylic acids used here are selected from acrylic acid, methacrylic acid, itaconic acid, maleic acid, maleic anhydride, fumaric acid, monomethyl maleic acid, and mixtures thereof.

The ethylene acid copolymers used herein may be polymerized as described in U.S. Pat. Nos. 3,404,134; 5,028,674; 6,500,888; and 6,518,365, for example.

To produce the ionomers used here, the acid moieties of the ethylene acid copolymers are neutralized. The extent of the neutralization may be 100 mole % or less, or about 5 to about 90 mole %, or about 10 to about 50 mole %, or about 20 to about 40 mole %, based on the total number of equivalents of carboxylic acid moieties in the ethylene acid copolymers. Upon neutralization, the ionomers will be associated with one or more cationic counterions, such as metal cations or quaternary amines, for example. Suitable metal ions may be monovalent, divalent, trivalent, multivalent. Mixtures of cations of one or more of these valencies are also suitable. Useful monovalent metal ions include, but are not limited to, ions of sodium, potassium, lithium, silver, mercury, copper and the like and mixtures of two or more thereof. Useful divalent metal ions include, but are not limited to, ions of beryllium, magnesium, calcium, strontium, barium, copper, cadmium, mercury, tin, lead, iron, cobalt, nickel, zinc and the like and mixtures thereof. Useful trivalent metal ions include, but are not limited to, ions of aluminum, scandium, iron, yttrium and the like and mixtures of two or more thereof. Useful multivalent metal ions include, but are not limited to, ions of titanium, zirconium, hafnium, vanadium, tantalum, tungsten, chromium, cerium, iron and the like and mixtures of two or more thereof. It is noted that when the metal ion is multivalent, complexing agents, such as stearate, oleate, salicylate, and phenolate radicals may be included, as described in U.S. Pat. No. 3,404,134. Processes by which the ethylene acid copolymers may be neutralized to form the ionomers are also described in U.S. Pat. No. 3,404,134.

Although polymeric interlayers are preferred, especially in glass-less laminates because of their flexibility, it may be necessary or desirable for an interlayer to have a multilayer structure that includes a rigid sheet, for example a PVB/glass/PVB structure, or a PVB/polycarbonate/EVA/polycarbonate/PVB structure.

In general, the engineering requirements of the intended end use of the laminate will dictate the selection of the materials and structure of the interlayer. It is apparent that the outer surfaces of the interlayer should be formed from materials that are capable of bonding to the outer layers of the laminate, and that the internal structure of the interlayer should have sufficient integrity after lamination for the intended end use of the laminate.

Additional film or sheet layers may be included in the laminates, or more functionality may be included in the layers of the laminate. For example, solar control materials (e.g., infrared absorbing materials such as indium tin oxide, antimony tin oxide lanthanum hexaboride, phthalocyanines, naphthalocyanines, and rylenes; infrared reflecting materials, such as chiral or achiral nematic liquid crystals; sputtered metal coatings, such as silver; or combinations of two or more thereof may be incorporated into or applied onto the polymeric interlayers or the plastic film outer layers. Alternatively, an interlayer may have a structure such as PVB/PET with solar control coating/PVB.

In addition, to achieve sufficient bonding strength between the laminate's layers, adhesives may be applied to the surface of one or more of the component layers of the laminates. Commonly used adhesives include, but are not limited to, poly(alkyl amines) (e.g., poly(allyl amines)) and silanes (e.g., amino-silanes).

### Release Liner

The release liner is a film comprising an inbound layer and an outbound layer. Each of the inbound and outbound layers comprises a polymeric material. The polymeric material comprised in the outbound layer has a melting temperature that is higher than the temperature reached by the inbound layer in the lamination process. Preferably, the melting temperature of the polymeric material comprised in the outbound layer is at least 10° C. higher than the melting temperature of the polymeric material comprised in the inbound layer. During the lamination process, the bi-layer release liner is placed between the hardcoated plastic film layer and the cover plate, with the inbound layer adjacent to the hardcoated plastic film layer and the outbound layer adjacent to the cover plate.

Although the release liner may comprise more than two layers, it is referred to herein as a “bi-layer film”. Any suitable polymeric materials may be used in forming the bi-layer release liner. In particular, the inbound layer may comprise, without limitation, polyethylenes, polypropylenes, ethylene copolymers (e.g., poly(ethylene-co-vinyl acetates) (EVA) and poly(ethylene-co-methyl acrylates)), other similar polyolefins, and combinations of two or more suitable materials. Polymers that may be comprised in the outbound layer include nylons, polyesters, polypropylenes, other similar polyolefins, and combinations of two or more suitable materials. In addition, each of the component polymeric layers comprised in the bi-layer release liner may be non-oriented, oriented, or bi-axially oriented. Preferably, however, the material of the inbound layer is not oriented, and the material of the outbound layer is biaxially oriented. Without wishing to be held to theory, it is believed that biaxially oriented films are flatter, and that they therefore provide a more optically perfect laminate.

Preferably, the bi-layer release liner comprises an inbound layer formed of polyethylene. Also preferably, the polymeric material of an inbound layer comprising the polyethylene composition further comprises a certain amount of poly(ethylene-vinyl acetate) to enhance its adhesion to the adjacent plastic outer layer of the laminate. The level of poly(ethylene-vinyl acetate) may be a non-zero amount up to about 20 wt %, based on the total weight of the composition of the inbound layer. Preferably, the level of poly(ethylene-vinyl acetate) is a non-zero amount up to about 10 wt % or a non-zero amount up to about 5 wt %. As an adjunct or alternative to the poly(ethylene-vinyl acetate), the inbound layer may include another modifier or additive to enhance the adhesion of the bilayer release liner to the substrate film. Such modifiers and additives are known to those of skill in the art. See, e.g., the Kirk Othmer Encyclopedia of Chemical Technology, 5^{th} Edition, John Wiley & Sons (New Jersey, 2004) or the Modem Plastics Encyclopedia, McGraw-Hill (New York, 1995). Still more preferably, at least one surface of the inbound layer (e.g., the surface that is adjacent to the plastic outer layer) has undergone an energy treatment or is coated with one or more primers, as described above, to further improve its adhesion properties.

Those of skill in the art will know how to adjust the amount of poly(ethylene-vinyl acetate), in conjunction with any other additives, primers, modifiers, adhesives and treatments, to achieve a suitable peeling strength between the laminate and the release liner. Suitable peeling strengths are set forth below.

Preferred polymeric materials for use in outbound layers comprise or are formed of polypropylene or polyester or nylon. Polyethylene terephthalate (PET) and polypropylene are more preferred materials.

Additional layers that may be present in the release liner include, without limitation, structural layers to promote the integrity or ease of handling of the release liner. For example, an intermediate layer (e.g., a film formed of poly(ethylene terephthalate) or polypropylene) may be present between the inbound and outbound layers.

More preferably, the bi-layer release liner comprises an inbound layer formed of polyethylene and an outbound layer formed of polypropylene. In such a polyethylene/polypropylene bi-layer structure, it is yet more preferred that the polyethylene have a melting temperature ranging from about 110° C. to about 115° C. and that the polypropylene have a melting temperature ranging from about 160° C. to about 170° C. Also preferably, the outbound layer is a bi-axially oriented polypropylene film. Still more preferably, the inbound layer is a non oriented polyethylene layer and the outbound layer is a bi-axially oriented polypropylene layer.

In general, the thickness of the release liner has an upper bound that is determined by the heat transfer capabilities of the release liner. That is, above a certain thickness, the release liner may impede the flow of heat through the laminate such that the lamination process becomes unfeasibly slow or inefficient. The lower bound of the thickness is determined by the sizes of the particulate contaminants that are desired to be entrapped and by the processibility of the harder outbound layer. The outbound layer thickness should be great enough to insure uniform caliper across the film, as achievable via extrusion or coextrusion of the layers.

Preferred bi-layer release liners, however, generally have a total thickness of up to about 5 mils (127 μm), or about 1 to about 4 mils (about 25 to about 102 μm), or about 1 to about 2 mils (about 25 to about 51 μm). It is further preferred that the inbound layer have a thickness not exceeding about 1.5 mils (38 μm) or about 1 mil (25 μm) and the outbound layer have a thickness not exceeding about 3 mils (76 μm) or about 1.5 mils (38 μm) or about 1 mil (25 μm).

Also notably, there is an upper limitation to the optical flatness that can be achieved with an intermediate material placed between the cover plate and the plastic outer layer of the pre-lamination structure. This threshold correlates to the quality of the liner flatness and is also dependent upon laminating conditions such as cover plate contact, applied pressure and/or vacuum, and temperature.

In some applications, it may be preferred that the release liner remain attached to the plastic film or sheet layer after the lamination process and the cover plate removal, but prior to the laminate's deployment in its end-use application. This is usually the case when the surface of the laminate should be protected from insults that may be sustained in transit or in installation. In such situations, it is preferred that the bi-layer release liner be colored so that it can be easily detected and stripped off before the laminate is deployed in the end use. Therefore, one or more dyes, colorants or pigments may be incorporated into one or more layers of the release liner. Alternatively, the release liner may be printed with a solid coloration, words, or images. Combinations of two or more coloration techniques may also be used.

The polymeric materials from which the release liner is formed may further contain additives, of the same types set forth above with respect to the polymeric interlayers. With the possible exception of plasticizers, the additives may also be present in the amounts set forth above with respect to interlayers.

The bi-layer polymeric film may be prepared by any suitable process. It is preferred, however, that the film be prepared by a co-extrusion process. Moreover, it is preferred that one surface or both surfaces of the bi-layer release liner be embossed to facilitate the de-airing during the lamination process. More preferably, the surface of the outbound layer is embossed.

Two of the factors that have a significant influence on the optical quality of a glass/plastic laminate are the optical flatness and the hardness of the release liner. Specifically, a mono-layer release liner having an embossed surface and comprising a polymer with a relatively higher melting temperature, such as polypropylene, can be an effective release liner in de-airing. Some harder monolayer films have a tendency to impart faint ripples or even notable lines to the laminate's surface, however. These lines are the impressions made on the laminate by the release film's die-directional extrusion lanes. A deeply embossed film might even leave the lasting impression of its embossed pattern on the laminate.

In addition, as noted above, biaxial orientation may improve the optical flatness of the release liner, leading to an improvement in the overall optical quality of the laminate. Many biaxially oriented films are also rigid or crystalline, however. In general, harder mono-layer release liners may not be effective in masking or entrapping the particulate contaminants. Moreover, they may have a tendency to exacerbate the impressions on the surface of the laminate that are caused by particulate contaminants.

On the other hand, a mono-layer release liner that is comprised of a polymer with a relatively lower melting temperature, such as polyethylene, can mask and entrap particulate contaminants more effectively. Concomitantly, the transfer of surface variations and embossing, if any, of the softer release liners to the laminates is minimized. These variations and textures are also diminished by the softening of the release liner at lamination process temperatures and pressures.

Nevertheless, also due to the lower melting temperature, softer release liners may have the tendency to melt too early during the heating of the lamination. For this reason, air may be trapped in pockets across the surface of the plastic film. This is especially true for larger laminates which may require longer and/or higher temperature heating cycles for lamination. In addition, the softer films are more prone to degradation in long cycles or when processed in the autoclave at higher temperatures (150° C. or higher). The result of this degradation is a mottled, dimpled effect on the laminate surface.

Surprisingly, the use of a bi-layer release liner that is comprised of an inbound layer of lower melting temperature and an outbound layer of higher melting temperature provides a more efficient release liner. A particularly preferred release liner configuration pairs a layer having the optical flatness of a bi-axially oriented film with a layer having the contamination control capabilities of a softer, non-oriented polyolefin film.

Also advantageously, by using a bi-layer release liner, it becomes possible to set the temperatures of the nip rolls above melting point of the polymer (e.g., polyethylene) that is comprised in the inbound layer without melting the polymer (e.g., polypropylene) that is comprised in the outbound layer. Thus, the liner may be thermally applied to the plastic outer layer of the pre-lamination assembly prior to lamination while maintaining the surface pattern of the outbound layer. The outbound layer can then perform optimally in its ability to release any trapped air during lamination. The release liner will also preferentially remain with the laminate after the autoclave step and the cover plate removal. Because the release liner remains adhered to the laminate, it is equipped with a protective “skin” that can remain in place until removed upon deployment of the laminate in its intended use.

Also, because the cover plate is smoothly released from the bi-layer film, it may readily be re-used. In general, when a release liner is not used, the preparation of cover plates for re-use is exacting. Both cleaning and passivation of the reactive moieties on the glass surface may be required. When a release liner is used, however, the preparation of glass cover plates for re-use is greatly simplified. Often, the glass surface needs only to be cleaned according to the usual procedure for glass lamination.

### Lamination Process

Further provided herein is a lamination process. For glass/plastic laminates, the lamination process comprises the following steps.

First, a pre-press or pre-lamination assembly is formed by positioning all the component layers in the order of a glass outer layer, a polymeric interlayer, and an optionally hard-coated plastic film outer layer, a bi-layer release liner as described above, and a rigid cover plate, wherein the release liner has its inbound layer adjacent to the plastic film outer layer and its outbound layer adjacent to the cover plate. The cover plate used here is preferably formed of glass or other suitable rigid materials and is similar in shape and curvature to the glass outer layer. The structure as assembled above then undergoes a lamination process with or without an autoclaving step.

An autoclave lamination process involves applying a vacuum to the assembly, for example with a vacuum bag or a vacuum ring. Alternatively, the method may entail pressing the assembly with nip rolls to expel air from between the layers. The expulsion of air from the pre-press assembly is followed by autoclaving the assembly (if necessary, together with the vacuum bag or vacuum ring) at a temperature of about 100° C. to about 170° C. and a pressure of about 2 to about 30 atmospheres so that the constituent layers of the laminate are firmly adhered together.

Non-autoclave lamination processes may be also used in conjunction with the methods described herein. Suitable non-autoclave processes are described in U.S. Pat. Nos. 3,234,062; 3,852,136; 4,341,576; 4,385,951; 4,398,979; U.S. Pat. Nos. 5,536,347; 5,853,516; 6,342,116; 5,415,909; in U.S. Patent Appln. Publn. No. 2004/0182493; in European Patent No. 1 235 683 B1; and in Intl. Patent Appln. Publn. Nos. WO 91/01880 and WO 03/057478, for example. In general, a non-autoclave process includes the steps of heating the pre-lamination assembly and applying vacuum, pressure or both thereafter. For example, the pre-lamination assembly may be successively passed through one or more heating ovens and nip rolls.

At this stage of the process, contaminants that have been trapped between the cover plate and the release liner will have been pressed into the inbound surface of the release liner. This leaves the final glass/plastic laminate substantially free of objectionable optical defects.

After cooling and/or depressurization, the cover plate is removed. To obtain the final glass/plastic laminate, the bi-layer release liner is then stripped away from the plastic film outer layer simultaneously with or after the cover plate removal and before deployment in the end-use application of the laminate. By stripping away the release liner, most particulate contaminants will be removed from the surface of the laminate. It may be found that some particulate contaminants remain on the surface. However, since they have not marred the surface of the plastic film layer and damaged its optical quality, they may be removed mechanically.

For ease of description, the preparation of glass/plastic laminates is set forth in detail above. Those of skill in the art, however, are readily able to adapt these methods to the preparation of glass-less laminates. For example, to prepare a simple glass-less laminate, such as a PET film/PVB/PET film laminate, the pre-press assembly may be laid up as “first cover plate/first bilayer release liner with softer surface facing towards the first PET film/first PET film/PVB sheet/second PET film/second bi-layer release liner with softer surface facing towards the second PET film/second cover plate”. The first and second PET films, cover plates and bi-layer release liners may be the same or different. The remainder of the steps in the lamination process are carried out substantially as described above with respect to the glass/plastic laminates. In a further example, those of skill in the art are well aware that the methods described herein may be superfluous if the plastic outer layer(s) are rigid plastic sheet(s).

In some processes, the surface of the inbound layer may be further treated to improve the adhesion between the bi-layer release liner and the plastic film layer. Suitable treatments are as described above with respect to the adhesion between the plastic film and its hard coat.

Optionally, alone or in combination with other techniques to improve adhesion, a thin layer of a low tack pressure sensitive adhesive may be applied to the surface of the inbound layer. In addition to increasing adhesion, this step further facilitates the application of the release liner at room temperature to the plastic film outer layer. One suitable pressure sensitive adhesive is an acrylic polymer composition, Type 2021-03-CL, supplied by Main Tape of Wisconsin, Plymouth, Wis. The adhesive may be applied at a thickness of about 0.1 to about 0.2 mils (2.5-5.1 μm).

As discussed above, it is sometimes preferred that the release liner remain removably attached to the plastic film layer after the lamination process and the cover plate removal. Adhesive enhancement of the liner to the plastic film via thermal lamination, the use of adhesive additives such as EVA copolymer in the inbound layer, application of plasma or corona treatment, inclusion of pressure-sensitive adhesive layers, or a combination of two or more of these techniques may assist the release liner in remaining releasably adhered to the plastic film layer after the cover plate removal. It is recognized, however, that the adhesion between the plastic film layer and the release liner should not exceed a level at which it may be detrimental to the integrity of laminate when the release liner is stripped off the laminate. More specifically, it is preferred that the peeling strength between the release liner and the plastic film layer not exceed about 5 lb*f/in, about 2 lb*f/in, or more preferably, that the peeling strength range from about 0.01 to about 0.1 lb*f/in.

### Composite Laminate Structures

Further provided is a composite laminate structure comprising a glass/plastic or a glass-less laminate and, releasably adhered to one or both of the plastic sides thereof, a bi-layer release liner. Specifically, the composite laminate structure is a structure resulting from the above described lamination processes, after the cover plate is removed but before the release liner is stripped off. The term “releasably adhered”, as used herein, means that release liner is adhered to a plastic side of the laminate at an adhesion strength not exceeding the adhesion strength between the component layers of the laminate, so that the release liner can be stripped away from the laminate without damaging the integrity of the laminate. Preferably, the peeling strength between the release liner and the plastic side of the laminate should not exceed about 5 lb*f/in, about 2 lb*f/in, or more preferably, range from about 0.01 to about 0.1 lb*f/in.

The following examples are provided to describe the invention in further detail. These examples, which set forth a preferred mode presently contemplated for carrying out the invention, are intended to illustrate and not to limit the invention.

### EXAMPLES

### Standard Lamination Procedure

A pre-press assembly, in which all the layers in the glass/plastic laminate are cut to the same size and stacked in the desired order, was prepared from layers including, in sequence, an annealed float glass sheet of ⅛ or ¼ inch (3.2 or 6.3 mm) in thickness as the cover plate, a release liner, a biaxially oriented PET film 7 mils (178 μm) in thickness that bore a proprietary hardcoat on the surface that was adjacent to the release liner, a Butacite® sheet 15 or 30 mils (381 or 762 μm) in thickness, and a tempered or annealed float glass sheet of ⅛ or ¼ inch (3.2 or 6.3 mm) in thickness. The dimensions of the pre-press assembly were 12″12″ (305×305 mm). When a bi-layer release liner was used, the softer side was proximal to the PET layer.

The pre-press assembly was placed into a vacuum bag and heated at 90 to 100° C. for 30 minutes to remove any air contained between the layers of the pre-press assembly. The pre-press assembly was heated at 135° C. for 30 minutes in an air autoclave at a pressure of 200 psig (14.3 bar). The air was then cooled without adding additional gas, so that the pressure in the autoclave decreased. After 20 minutes of cooling, when the air temperature was less than about 50° C., the excess pressure was vented, and the laminate was removed from the autoclave. The release liner and the adjacent annealed float glass layer were removed to produce a glass/plastic laminate including a hard-coated layer of biaxially oriented PET film, a Butacite® layer, and a layer of glass.

The ease of removal of the release liner and the optical properties of the glass/plastic laminate were evaluated qualitatively. The results of these qualitative evaluations are set forth in Table 1, below, which in some cases summarizes the results from one or more experiments based on a single type of release liner.

The optical quality of the laminates was also judged. Consistently with the theories posited above, the bi-axially oriented films, such as C5 and E4, produced a significant improvement in optical quality versus the non-oriented films. Harder monolayer films, such as C4 and C5, also had a tendency to impart faint ripples or even notable lines to the laminate's surface, as a result of surface patterns or embossing.

In contrast, monolayer release films made of lower melting materials, such as C1 and C2, were affected less by particle entrapment defects and by the transfer of surface variations and embossing, if any. They were relatively harder to manipulate, however.

The preferred release liner configuration is therefore a bi-layer release liner pairing the optical flatness of a bi-axially oriented film with the particulate contamination control capabilities of a softer, non-oriented polyolefin film. Examples E2 and E4 have this preferred configuration.

TABLE 1

| | | | | | Mitigation of | Embossment | Adhesion | Adhesion | Manual |
|---|---|---|---|---|---|---|---|---|---|
| Sample | Release Liner | Thickness of | | | Particulate | Transfer to | to | to Cover | Application |
| No. | Material | Release Liner | | De-airing | Contaminants | Hardcoat | Hardcoat¹ | Plate¹ | & Handling |
| C1 | PE | >0.5 | mil | Poor | Good | No | No | Yes | Difficult |
| C2² | “PE+” | >1 | mil | Poor | Good | No | Varies³ | Varies³ | Difficult |
| C3 | PP | >1 | mil | Good | Varies | Varies | No | No | Easier |
| C4 | PE/PP blend | >1 | mil | Varies | Varies | Varies | Varies³ | Varies³ | Easier |
| C5⁴ | PE/Adhesive | >1 | mil | Varies | Varies | N/A | Yes⁵ | Yes⁵ | Difficult |
| E1 | PE/Nylon | 1 | mil (PE) | Good | Varies | No | Yes³ | No | Easier |
| | | 0.5 | mil | | | | | | |
| | | | (Nylon) | | | | | | |
| E2 | PE/boPET⁶ | >1 | mil PET | Good | Poor | No | Yes³ | No | Easier |
| | | 1 | mil PE | | | | | | |
| E3 | PE/PP | >1 | mil PE | Good | Good | No | Yes³ | No | Easier |
| | | 0.5 | mil PP | | | | | | |
| C5 | boPET⁶ | <1.5 | mil | Good | Poor | No | No | No | Easier |
| | | | boPET⁶ | | | | | | |
| E4⁷ | PE+PP blend/ | <1 | mil PE/PP | Good | Fair | No | Yes | No | Easier |
| | boPP | 1 | mil boPP | | | | | | |

¹“Adhesion to Hardcoat” and “Adhesion to Coverplate” each represent the inclination of the material post-lamination. As the coverplate is lifted, the material will either stick or “cling” to one of these two surfaces, or possibly cling to both surfaces (which, if bound tightly, results in difficult or impossible laminate recovery) or it may remain loose such that it clings to neither.
²The films used in comparative example C2 had adhesion-enhanced formulations (i.e., various amounts of added comonomers for adhesion, such as EVA, etc.)
³Certain films stuck too well to the hardcoat, cover plate, or both, making sample difficult or impossible to produce. For example, the melting point of the PE or the level of EVA contained in the “PE+” inbound layer could affect its adhesion to the adjacent hardcoated PET film or the cover plate.
⁴The films used in comparative example C5 are 3M tapes (3M Coporation, St. Paul, Minnesota) and Surface Guard tapes (Surface Guard, Inc., Aurora, IL) with smooth (non-embossed) surface.
⁵Adhesive films can be applied to either the coverplate or the hardcoated surface, and retain their adhesion to the applied surface after lamination.
⁶boPET was a bi-axially oriented PET film with adhesion treatment on one side and a silicone release agent on the outbound side as provided by Papertec, Inc. This film had an optically flat surface but provided zero particle mitigation.
⁷boPP was a bi-axially oriented polypropylene film. The final surface for this particular liner was optically superior to any of the others. Whereas non-oriented liners tended to impart extrusion “lines” on the surface of the finished laminate, the bi-axially oriented film did not. Whereas the monolayer bi-axially oriented films provided no mitigation against fine particles, this film did.

While a number of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A process for preparing a glass/plastic laminate comprising:
(a) forming a pre-lamination structure comprising, in the order given:
a glass outer layer, an interlayer, a plastic outer layer, a release liner, and a rigid cover plate, wherein (i) the release liner is a bi-layer film comprising an inbound layer comprising a first polymeric material and an outbound layer comprising a second polymeric material; (ii) the second polymeric material has a melting temperature at least 10° C. higher than the melting temperature of the first polymeric material; and (iii) the inbound layer is proximal to the plastic outer layer and the outbound layer is proximal to the rigid cover plate;
(b) applying sufficient heat, pressure or heat and pressure between the glass outer layer of the pre-lamination structure and the rigid cover plate to bond the interlayer to the plastic film and to the glass outer layer; and
(c) removing the cover plate and, optionally, the release liner to obtain the glass/plastic laminate.

2. The process of claim 1, wherein the outbound layer is uni-axially or bi-axially oriented.

3. The process of claim 1, wherein the first polymeric material comprises one or more polymers selected from the group consisting of polyethylenes, poly(ethylene-co-vinyl acetate)s, polypropylenes, and ethylene copolymers.

4. The process of claim 1, wherein the second polymeric material comprises one or more polymers selected from the group consisting of nylons, polyesters, and polypropylenes.

5. The process of claim 1, wherein the first polymeric material comprises a polyethylene, a poly(ethylene-co-vinyl acetate) or both a polyethylene and a poly(ethylene-co-vinyl acetate), and the second polymeric material comprises a polypropylene.

6. The process of claim 5, wherein the first polymeric material has a melting temperature of about 110° C. to about 115° C. and the second polymeric material has a melting temperature of about 160° C. to about 170° C.

7. The process of claim 1, wherein at least one surface of the release liner is embossed.

8. The process of claim 1, wherein at least the surface of the inbound layer that is adjacent to the plastic outer layer has undergone an energy treatment for improved adhesion.

9. The process of claim 8, wherein the energy treatment is selected from the group consisting of controlled flame treatment, corona treatment, and plasma treatment.

10. The process of claim 1, wherein at least the surface of the inbound layer that is adjacent to the plastic outer layer is coated with a primer.

11. The process of claim 10, wherein the primer comprises a material selected from the group consisting of silanes, poly(alkyl amines), and acrylics.

12. The process of claim 1, wherein the release liner has a total thickness of up to about 5 mils (127 μm).

13. The process of claim 12, wherein the total thickness of the release liner is about 1 to about 4 mils (about 25 to about 102 μm), the thickness of the inbound layer is up to about 1.5 mils (38 μm), and the thickness of the outbound layer is up to about 3 mils (76 μm).

14. The process of claim 1, wherein the plastic outer layer is a polyester film.

15. The process of claim 14, wherein the polyester film comprises a poly(ethylene terephthalate).

16. The process of claim 1, wherein the plastic outer layer further comprises an abrasion-resistant hardcoat that is disposed on the surface of the plastic outer layer that is adjacent to the release liner and wherein the abrasion-resistant hardcoat comprises a material selected from the group consisting of polysiloxanes, cross-linked polyurethanes, compositions prepared by the reaction of hydroxyl-containing oligomer with isocyanate-containing oligomer, and compositions prepared by the reaction of anhydride-containing oligomer with epoxide-containing compound.

17. The process of claim 1, wherein the rigid cover plate is a glass sheet.

18. The process of claim 1, wherein the surface of the inbound layer that is proximal to the plastic outer layer is at least partially coated with a pressure sensitive adhesive.

19. A process for preparing a glass-less laminate comprising:
(a) forming a pre-lamination structure comprising, in the order given:
a first rigid cover plate, a first release liner, a first plastic outer layer, an interlayer, a second plastic outer layer, a second release liner, and a second rigid cover plate, wherein (i) one or both of the first and the second release liners is a bi-layer film comprising an inbound layer comprising a first polymeric material and an outbound layer comprising a second polymeric material; (ii) the second polymeric material has a melting temperature at least 10° C. higher than the melting temperature of the first polymeric material; (iii) the inbound layer is proximal to the first or the second plastic outer layer and the outbound layer is proximal to the first or the second rigid cover plate; and (iv) the first and second bi-layer release liners may be the same or different;
(b) applying sufficient heat, pressure or heat and pressure between the two rigid cover plates to bond the interlayer to the plastic outer layers; and
(c) removing the first and second cover plates and, optionally, the first or second release liners to obtain the glass-less laminate.

20. A laminated structure comprising a first and second outer layer, a polymeric interlayer, and at least one bi-layer release liner, wherein,
(a) at least one of the two outer layers is a plastic outer layer and the polymeric interlayer is bonded between the two outer layers;
(b) the at least one bi-layer release liner has an inbound layer comprising a first polymeric material and an outbound layer comprising a second polymeric material;
(c) the second polymeric material has a melting temperature at least 10° C. higher than the melting temperature of the first polymeric material; and
(d) the bi-layer release liner is releasably adhered to the outside surface of the plastic outer layer and its inbound layer is proximal to the plastic outer layer.

21. The laminated structure of claim 20, wherein (i) the first outer layer is a glass outer layer and the second outer layer is the plastic outer layer; and (ii) the bi-layer release liner is releasably adhered to the outside surface of the second outer layer.

22. The laminated structure of claim 20, wherein the plastic outer layer further comprises an abrasion-resistant hardcoat that is disposed on the surface of the plastic outer layer that is proximal to the release liner, and wherein the abrasion-resistant hardcoat comprises a material selected from the group consisting of polysiloxanes, cross-linked polyurethanes, compositions prepared by the reaction of hydroxyl-containing oligomer with isocyanate-containing oligomer, and compositions prepared by the reaction of anhydride-containing oligomer with epoxide-containing compound.

23. The laminated structure of claim 20, wherein the first polymeric material comprises one or more polymers selected from the group consisting of polyethylenes, polypropylenes, and ethylene copolymers.

24. The laminated structure of claim 20, wherein the second polymeric material comprises one or more polymers selected from the group consisting of nylons, polyesters, and polypropylenes.

25. The laminated structure of claim 20, wherein the first polymer comprises a polyethylene and the second polymer comprises a polypropylene.

26. The laminated structure of claim 25, wherein the polyethylene has a melting temperature of about 110° C. to about 115° C. and the polypropylene has a melting temperature of about 160° C. to about 170° C.

27. A pre-lamination assembly comprising a first and second outer layer, a polymeric interlayer, at least one bi-layer release liner, and at least one rigid cover plate, wherein,
(a) at least one of the two outer layers is a plastic outer layer and the polymeric interlayer is disposed between the two outer layers;
(b) the at least one bi-layer release liner has an inbound layer comprising a first polymeric material and being proximal to the plastic outer layer and an outbound layer comprising a second polymeric material and being proximal to the rigid cover plate;
(c) the second polymeric material has a melting temperature at least 10° C. higher than the melting temperature of the first polymeric material; and
(d) the at least one bi-layer release liner is placed between the plastic outer layer and the at least one rigid cover plate with the inbound layer of the at least one release liner proximal to the plastic outer layer and the outbound layer of the at least one release liner proximal to the at least one rigid cover plate.

28. A process for preparing a laminate having at least one plastic film outer layer, comprising
(a) forming a pre-lamination structure comprising, in the order given: an interlayer, a plastic film outer layer, a release liner, and a rigid cover plate; and
(b) applying sufficient heat, pressure or heat and pressure between the interlayer and the rigid cover plate to bond the interlayer to the plastic film outer layer;
wherein the improvement comprises that the release liner comprises a bi-layer film, said bi-layer film comprising an inbound layer comprising a first polymeric material and an outbound layer comprising a second polymeric material;
wherein the second polymeric material has a melting temperature at least 10° C. higher than the melting temperature of the first polymeric material; and further wherein the inbound layer is proximal to the plastic film outer layer and the outbound layer is proximal to the rigid cover plate.
